(19) United States
(12) Patent Application Publication
(10) Pub. No.: US 2007/0061471 A1
(43) Pub. Date: Mar. 15, 2007

(54) Future delivery apparatus and method

(75) Inventors: Tyrone Glover, Media, PA (US); Glenda Logan-Glover, Media, PA (US)

Correspondence Address: ROBERT S. LIPTON, ESQUIRE, 201 NORTH JACKSON STREET, P. O. BOX 934, MEDIA, PA, 19063-0934, US

(73) Assignee: Preserving Sentiments, Inc., Media, PA (US)

(21) Appl. No.: 11/407,592

(22) Filed: Apr. 20, 2006

Related U.S. Application Data
(60) Provisional application No. 60/716,036, filed on Sep. 9, 2005.

(51) Int. Cl. G06F 15/16

(52) U.S. Cl. 709/228; 709/206

(57) ABSTRACT

The Invention is an apparatus and method for delivering communications to an intended recipient upon the occurrence of a predetermined condition in the future. A subscriber subscribes on-line with a delivery services provider. The subscriber creates or orders a communication, which may include a good or service. Upon the occurrence of the predetermined condition, the delivery services provider locates the intended recipient and delivers the communication. For a written communication, the delivery services provider prints the communication and delivers the printed communication. The service is financed by an up front payment, by creation of a deposit account, or by purchase of a policy of insurance, all facilitated by the delivery services provider.

### RELATED APPLICATIONS

This application is a Continuation in Part of provisional patent application No. 60/716,036 filed Sep. 9, 2005.

### BACKGROUND OF THE INVENTION

A. Field of the Invention

The invention is a computer-implemented delivery system for messages and journal entries. The Invention is particularly useful for delivery of messages many years in the future, as to a message writer's children or grandchildren.

B. Description of the Prior Art

Message delivery systems are known in the prior art, including message delivery utilizing the Internet. The prior art does not teach the message delivery system of the Invention.

### SUMMARY OF THE INVENTION

The Invention is a computer-implemented system of delivering a communication from a subscriber to an intended recipient upon the occurrence of a predetermined condition in the future. The Invention is implemented using a computer network such as the Internet. A person (referred to herein as a “subscriber”) subscribes on-line to a future delivery service offered by a delivery services provider. Alternatively, an insurance agent, financial services representative or other person (referred to herein as a “sales agent”) may sell representative or other person (referred to herein as a “sales agent”) may sell the future delivery service of the Invention to the subscriber as an adjunct to the sale of another good or service. The sales agent may assist the subscriber in subscribing to the service.

Upon completion of the subscription process, the subscriber may prepare or order one or more communications for future delivery to the intended recipient. Upon the occurrence of the predetermined condition specified by the subscriber, the delivery services provider will take the steps necessary to deliver the communication to the intended recipient. For written communications such as messages, letters, greeting cards, journals or eulogies, the delivery services provider will retrieve the communication from computer memory, will print the communication on paper or other suitable substrate and will deliver the printed communication to the designated recipient, either by mail or in person. The written communication may be bound by the delivery services provider. If the communication is the delivery of a good or service, the delivery provider will cause the good or the service to be delivered to the intended recipient.

As used in this application, the term “communication” means any message, greeting card, letter, information, good or service that the subscriber may wish to have delivered in the future to the intended recipient. For example, the communication may comprise a letter created by the subscriber to the intended recipient. The communication may comprise a journal maintained by the subscriber over a period of time. The goods and services contemplated within the definition of “communication” may include any good or service offered for sale by the delivery services provider to the subscriber for delivery to the intended recipient at a time in the future. Examples include without limitation flowers, jewelry and memorabilia.

The term “communication” also means messages provided by persons who are not the subscriber. The providing of communications by persons who are not the subscriber is referred to herein as the “journal append” function. After the death of the subscriber, interested persons utilizing client computers may utilize the journal append function to log onto a web site maintained by the delivery services provider or by a funeral home. The third parties may offer eulogies, remembrances or images relating to the deceased subscriber. The communications using the journal append function may be printed, bound and delivered to the intended recipient as directed by the deceased subscriber.

As used in this application, the term “written communication” means any communication that can be stored in computer memory and printed, such as a message, letter, journal, greeting card or image.

To prepare or order the communication, the subscriber will use a client computer to communicate with a server computer over the computer network. Alternatively, a sales agent using a client computer may communicate with the server computer over the computer network on behalf of subscriber. Where the computer network is the Internet, the subscriber or the sales agent will log onto a web site under the control of the delivery services provider. The subscriber will be provided the opportunity to create and save a written communication. The subscriber also will be provided the opportunity to purchase a good or service. Written communications and orders for goods and services are stored in computer memory under the control of the delivery services provider until the occurrence of the predetermined condition.

The term “predetermined condition” means the occurrence of any event that can be identified. For example the predetermined condition may be the passage of a specified date or term of years. The predetermined condition may be a life event, such as the death or incapacity of the subscriber, marriage of the intended recipient, or birth of a child. The predetermined condition may be the occurrence of a political event, such as an election.

Due to the passage of time, the intended recipient may no longer be available at the address specified by the subscriber. The delivery services provider may use locator services to locate the intended recipient.

The delivery service provider may charge a subscription fee to the subscriber and may charge maintenance fees during the period of the subscription. The delivery services provider will charge a separate delivery charge for the future delivery of a communication, which may include a product or service, to the intended recipient.

The subscriber may have several options to pay the delivery charge. First, the subscriber may be given the option of paying for the communication in full at the time of subscription, at the time of creating the communication, or at the time of ordering the good or service. As a second payment option, the subscriber may be provided the alternative of creating a new financial account to pay the delivery charge. As a third payment option, the subscriber may be provided the opportunity to purchase an insurance product. The proceeds of the insurance product or withdrawal of the cash value of the policy may be used to pay the delivery charge in the future.

For the financial account method of financing the delivery charge, the delivery services provider creates an interest-bearing financial account on behalf of the subscriber with a financial services provider as a part of the subscription process. The subscriber pays an amount to the delivery service provider, which the delivery services provider deposits in the financial account. The account and the money contained within the account are owned by the subscriber. The subscriber can cancel the service and withdraw the money from the account at will, less a termination fee paid to the delivery services provider. The financial account method of financing has the benefit of providing the subscriber with maximum flexibility and the option of terminating the subscription in the future.

For the insurance product method of financing, the delivery services provider accepts an application for an insurance product and a premium from the subscriber as a part of the subscription process. Any suitable insurance product may be used, such as a policy of whole life insurance, a policy of term life insurance or an annuity. The delivery services provider submits the application and premium to an insurance provider on behalf of the subscriber. The insurance provider issues the insurance product. The delivery services provider makes a claim upon the insurance provider upon satisfaction of the condition causing contractual liability on the part of the insurance provider under the insurance product. The insurance provider then pays the proceeds of the insurance product to the delivery services provider to fund an account for the purchase and delivery of the communication. The insurance product method of financing is most applicable to predetermined conditions occurring after the death of the subscriber.

An intended recipient may have no desire to receive communications from the subscriber. The intended recipient is provided the opportunity to opt out of receiving communications either from subscriber or from anyone else.

### SUMMARY OF THE FIGURES

FIG. 1 is a schematic diagram of the apparatus of the Invention.

FIG. 2 is an overview flow diagram of the method of the invention, including the financial account and insurance financing options.

FIG. 3a-3c is a flow chart of the account set up process.

FIG. 4a-4c is a flow chart of the set up of the intended recipient of a communication.

FIG. 5a is a flow chart of the creation of a communication, in this instance a letter or message.

FIG. 5a is an example of creation of a communication by the process of FIG. 5a.

FIG. 6 is a flow chart of the creation of a communication, in this instance a journal.

FIG. 7a-7b is a flow chart of user prompted letter retrieve.

FIG. 8 is a flow chart of scheduled letter retrieve.

FIG. 9 is a flow chart of user prompted journal retrieve.

FIG. 10 is a flow chart of scheduled journal retrieve.

FIG. 11 is a flow chart of funeral services account access.

FIG. 12 is a flow chart of journal append funeral services guest account.

FIG. 13 is a flow chart of guardian review.

FIG. 14 is a flow chart of intended recipient opt out.

FIG. 15a-15b is a flow chart illustrating ordering a good or service as part of a communication for future delivery.

### DESCRIPTION OF AN EMBODIMENT

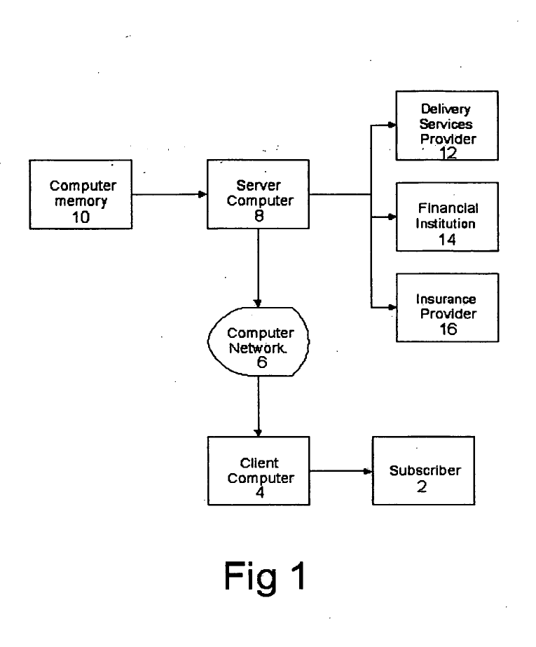

The Invention is an apparatus and method for providing communications to persons at a future time. As shown by FIG. 1, a subscriber 2 utilizes a client computer 4 to access a computer network 6. Alternatively, a sales agent may utilize the computer network 6 on behalf of subscriber 2. As used in this application, a “client computer” 4 is any computer capable of communicating with a server computer 8 utilizing a computer network 6. The computer network 6 may be the Internet. As used in this application, a “server computer” 8 is any computer system or network capable of receiving a communication from a client computer 4 and responding to that communication. The server computer 8 preferably is capable of transmitting an electronic signal to the client computer 4 that is displayed on a screen or other computer monitor to the subscriber 2. The server computer 8 may comprise a single computer or may comprise multiple computers. The multiple computers may be physically located at multiple locations and under the control of multiple entities. The multiple computers comprising the server computer 8 may communicate with each other over a computer network 6.

The server computer 8 has an associated computer memory 10 in which the server computer 8 may store information. The server computer 8 preferably is in communication with a delivery services provider 12, a financial institution 14 and an insurance provider 16. The web site content displayed by the server computer 8 is under the control of the delivery services provider 12.

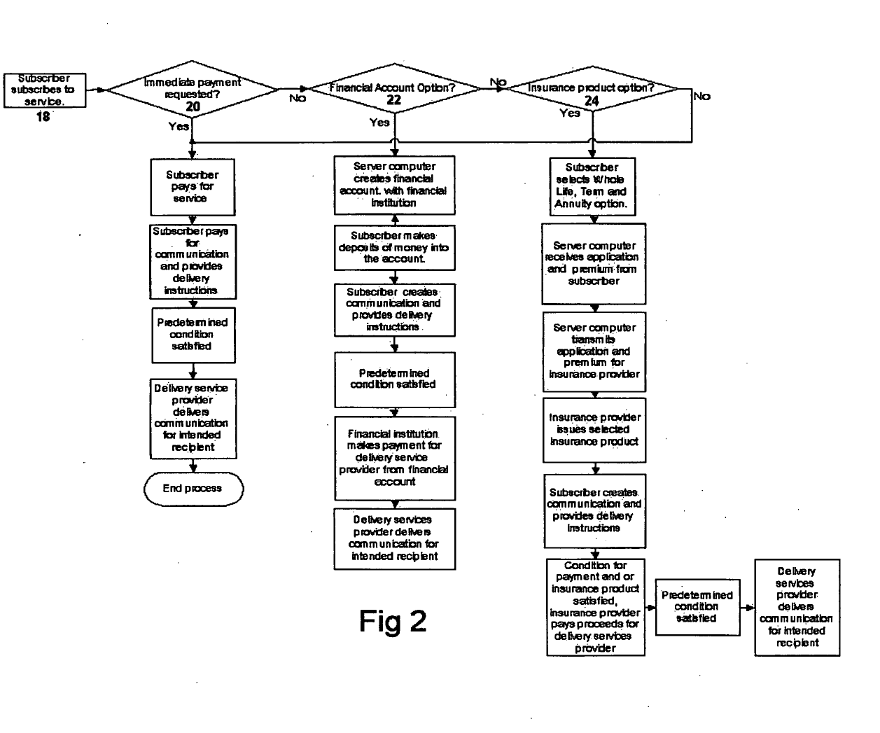

FIG. 2 is a schematic flow chart of the payment system of the Invention. As shown by element 18 of FIG. 2, the applicant applies for a subscription account. The first payment inquiry is whether the services desired by subscriber 2 require immediate payment, shown by element 20 of FIG. 2. An ordered communication may require immediate payment, for example, the payment of an initial subscription fee or maintenance fee, or where the delivering of a communication by a delivery services provider 12 is scheduled within a short time after ordering delivery of the communication by the subscriber 2. If immediate payment is required as shown by element 20 of FIG. 2, the subscriber 2 will submit payment and will create the communication, which may include ordering a good or service. Upon satisfaction of the predetermined condition, such as the passage of a predetermined period of time, the delivery services provider will deliver the communication, which may include delivery of the good or provision of the service, to the intended recipient.

If immediate payment by the subscriber 2 is not required, the subscriber is provided the option of opening a financial account or of ordering an insurance product, illustrated by elements 22 and 24 of FIG. 2, respectively. The financial account 22 and the insurance product 24 allow the subscriber 2 to finance the future delivery of the communication by the delivery services provider 2 to the intended recipient.

If the subscriber 2 selects the option 22 of opening a financial account, the server computer 8 creates the financial account on behalf of the subscriber 2 with a financial institution 14. The subscriber 2 agrees to the terms of a contract among a financial institution 14, the delivery services provider 12 and the subscriber 2. The terms of the contract specify that an interest-bearing account will be created with the financial institution 14 at a pre-determined interest rate, with interest paid into the account. The subscriber 2 makes a deposit of money with the delivery services provider 12, which in turn deposits the money in the financial account. The subscriber 2 creates the communication, which may include ordering a good or service for delivery. The subscriber 2 provides delivery instructions, including providing the name and address of the intended recipient. The subscriber 2 also identifies the predetermined condition determining when the communication will be delivered.

In the financial account options of FIG. 2, the subscriber 2 owns the account and can withdraw his or her money from the account at any time; however, the contract provides that the subscriber 2 will pay a termination fee should the subscriber 2 terminate the account. In the event of termination of the account by the subscriber 2, the financial institution 14 will pay to the delivery services provider 12 the amount of the termination fee. The contract may provide that the subscriber 2 agrees to pay a maintenance fee, for example an annual fee, during the life of the account. In such event, the financial institution 14 will pay to the delivery services provider 12 the amount of the maintenance fee periodically during the life of the account.

Upon the occurrence of the predetermined condition, such as the passage of a pre-determined date, the passage of a predetermined term of years or the death of the subscriber 2, the delivery services provider 12 will notify the financial institution 14 and the financial institution 14 will pay the amount of the account to the delivery services provider 12.

If the subscriber 2 specifies multiple different predetermined conditions, the financial institution 14 will pay the portion of the financial account allocated to the predetermined condition that has occurred. The remainder of the monies contained within the financial account will then remain in the account until the passage of another of the predetermined conditions specified by the subscriber 2.

Upon payment of money to the delivery services provider 12 from the interest-bearing account, the delivery services provider 12 will take action to fulfill the instructions of the subscriber 2. First, the delivery services provider 12 will locate the intended recipient as identified by the subscriber 2. Since several years may have elapsed between the instruction by the subscriber 2 and the occurrence of the predetermined condition and the intended recipient may no longer reside at the location specified by the subscriber 2. The delivery services provider 12 will utilize any of the tools readily available to locate individuals. Such services include Internet-based people finder services.

Upon location of the intended recipient, the delivery services provider 12 will deliver the communication specified by the subscriber 2. The service provided by the delivery services provider 12 may include printing and binding written communications to the intended recipient from the subscriber 2, delivery of goods such as flowers to the intended recipient, or providing any other service or benefit to the intended recipient.

If a surplus remains after delivery of the good or service to the intended recipient, the contract may provide that the remaining amount will be divided among the delivery services provider 12 and the financial institution 14. If the delivery of the good or service results in a shortfall, the delivery services provider 12 will absorb the cost.

As shown by FIG. 2, if the subscriber 2 does not select the financial account option 22, the subscriber is provided the option of selecting an insurance product option 24. If the subscriber selects the insurance product option 24, the subscriber 2 will select an insurance product to finance the future delivery of communications by the delivery services provider 12. The term “insurance product” as used in this application means a policy of whole life insurance, a policy of term life insurance or an annuity. The term “insurance product” also means any contract for the future payment of money offered by an insurance provider 16, which may be an insurance company.

Once the subscriber 2 selects the insurance product option 24 and selects an insurance product, the subscriber 2 submits an insurance application and an insurance premium to the server computer 8. The server computer 8 forwards the application and premium to an insurance provider 16. The insurance provider 16 then issues the selected insurance product, contractually binding the insurance provider 16 to pay money in the future. The subscriber 2 then creates the communication and provides delivery instructions, including identifying a predetermined condition for delivery of the communication. After the condition for payment under the insurance product is satisfied, the delivery services provider 12 will make a claim to the insurance provider 16 under the insurance product and the insurance provider 16 will pay a proceed of the insurance product to the delivery services provider 12. The delivery services provider 12 receives the payment as compensation for the delivery to the intended recipient of the communication ordered by the subscriber 2. Upon satisfaction of the predetermined condition for delivery of the communication, the delivery services provider 12 will deliver the communication, which may include delivery of a good or service, to the intended recipient.

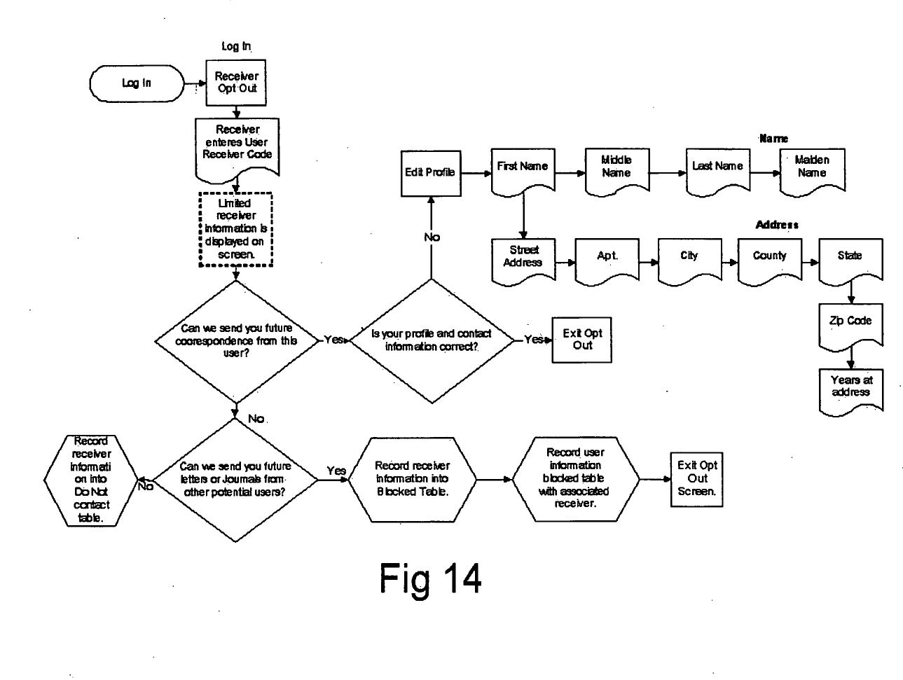

The insurance method of financing the future delivery of goods and services is particularly useful for predetermined conditions based on the death of the subscriber 2, such as delivering messages to survivors from the subscriber 2 or use of the “journal append” function (described below relating to FIG. 14) to allow persons other than the subscriber 2 to submit remembrances or eulogies of the subscriber 2, which then are reviewed by a guardian of the deceased, rejected or accepted, printed, bound and delivered to the survivors.

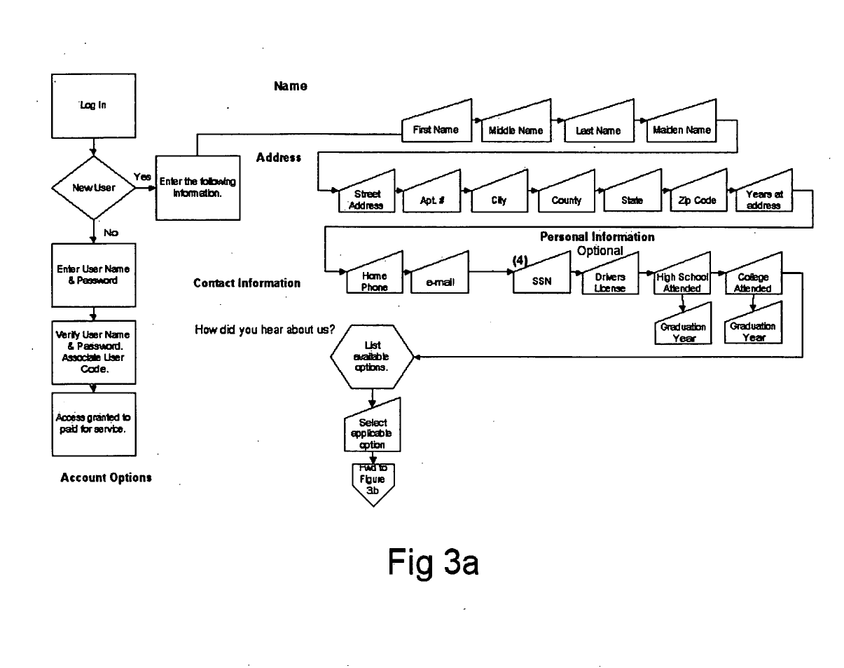

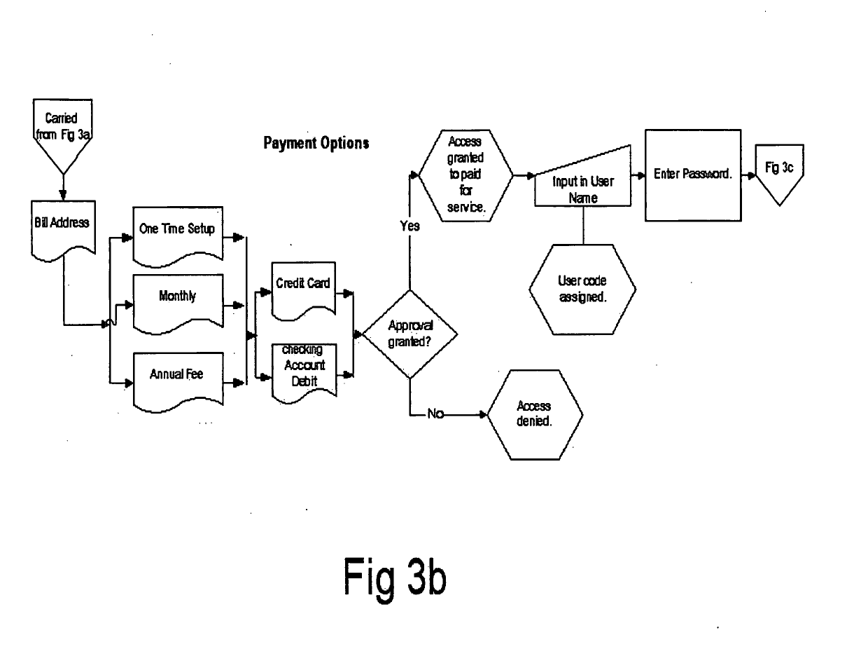

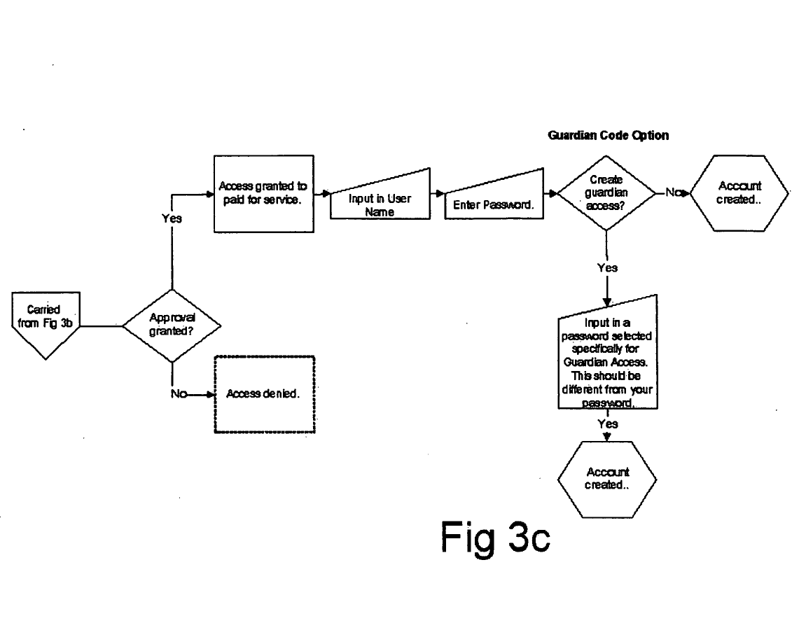

FIGS. 3-15 are flow charts of the operation of the Invention. FIGS. 3a-3c relate to account set up. A subscriber 2 utilizing a client computer 4 accesses a server computer 8 over the Internet. The server computer 8 hosts a web site under the control of the delivery services provider 12. The subscriber 2 navigates to screens allowing the subscriber 2 either to log on to the web site or to apply for a subscription account with the delivery services provider 12. The subscriber 2 without an existing account is asked to provide information about the subscriber 2, including name, address and the last four digits of the subscriber 2's social security number. The subscriber 2 is asked to designate a payment method, which may be a charge to a credit card or a charge to a funded financial account (as described above relating to FIG. 2). A charge for delivery services to be rendered after the death of the subscriber 2 may be funded by insurance, also as described above relating to FIG. 2. The subscriber 2 is prompted to select a subscriber 2 name and a password for future access to the web site and to associate communications with the subscriber 2. The subscriber 2 identifying information is included as a header and footer of each written communication associated with the subscriber 2's account to assist in formatting, printing, addressing and delivering of the communications upon the occurrence of the predetermined condition.

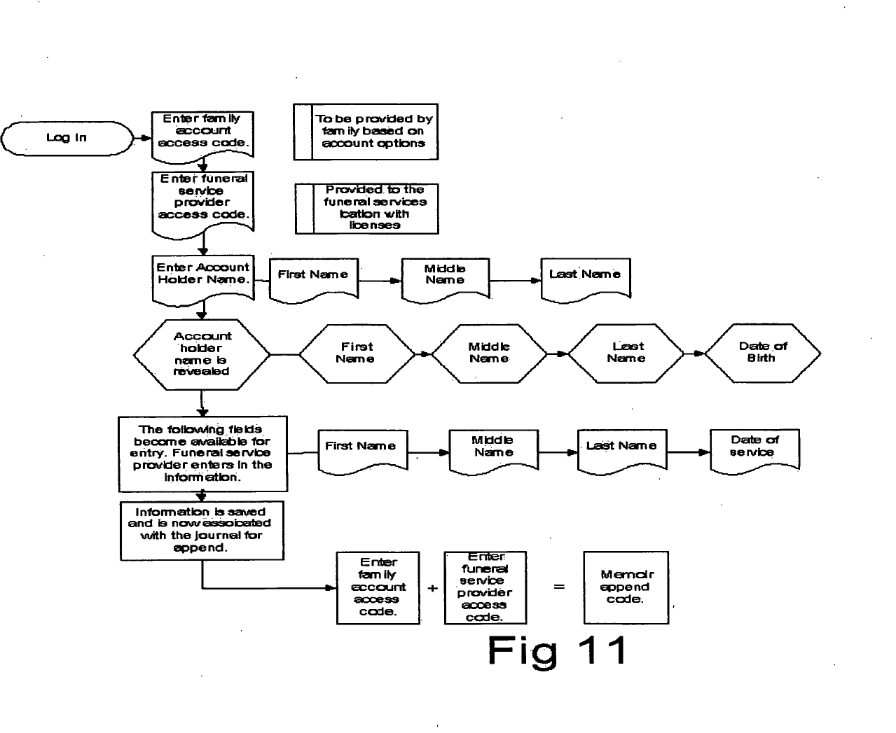

FIG. 3c is a continuation of FIG. 3a and 3b. Once the server computer 8 recognizes that setup is complete, the server computer 8 allows the subscriber 2 to navigate through the screens of the web site, to create or order communications and to save communications. The subscriber 2 optionally can authorize ‘guardian access;’ that is, allow one or more persons to access the ‘memoir append’ portions of the subscriber 2's account. Those persons can control the memoirs that are left by third persons if the subscriber 2 is not able to do so; for example, eulogies entered by third persons after the death of the subscriber 2 and as more fully described below relating to FIGS. 11 through 13.

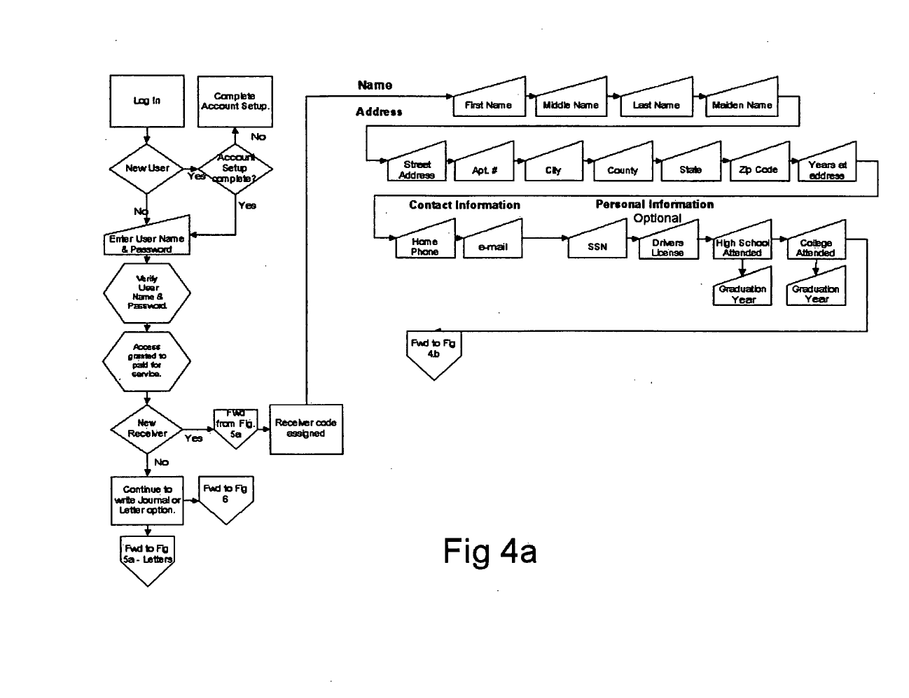

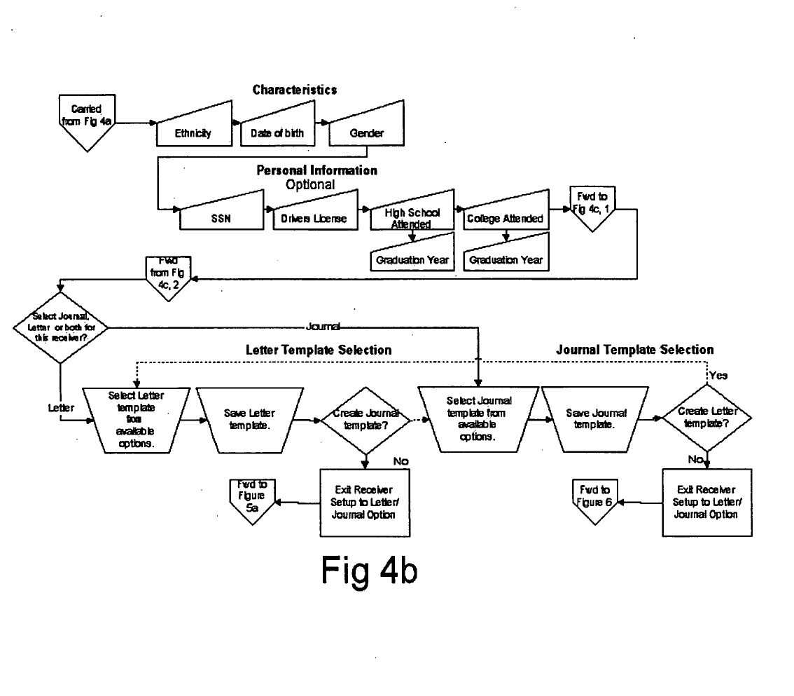

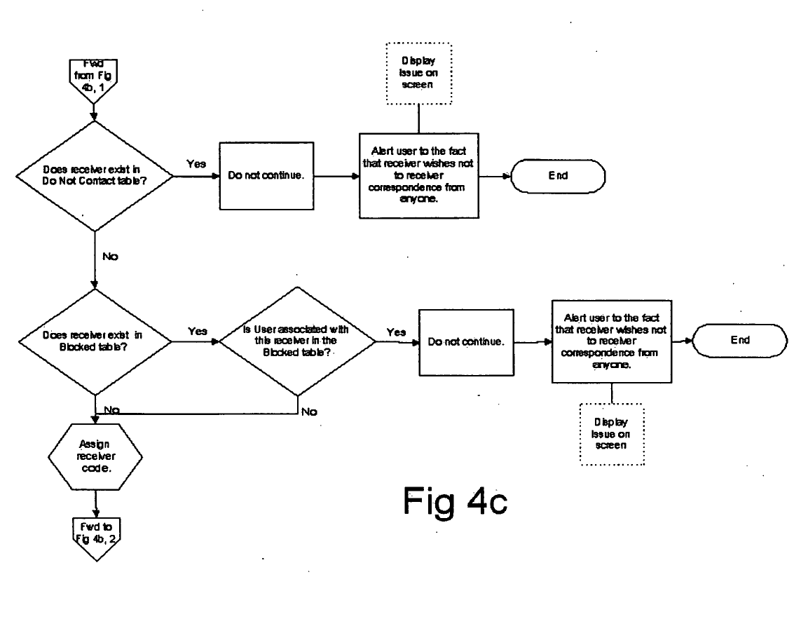

FIGS. 4a-4c relate to the entry of information about an intended recipient of a communication from the subscriber 2. The subscriber 2 is prompted to enter the intended recipient's identifying information. The identifying information will include the first, middle and last names of the intended recipient, the intended recipient's current street address and any other identifying information that may be able to assist in the location of the intended recipient after the occurrence of the predetermined condition. Such additional information may include the intended recipient's race or ethnicity, date of birth, gender, all or part of the intended recipient's social security number, driver's license number and any other information. The name, address and identifying information will be incorporated into header and footer record for each communication.

FIG. 4c is a continuation of FIGS. 4a and 4b and illustrates the steps taken by the delivery services provider 12 to determine whether the intended recipient has elected not to receive communications from the subscriber 2. The delivery services provider 12 will maintain “do not contact” and “blocked” databases of persons who do not wish to receive communications, as described below relating to FIG. 14. Upon selection of an intended recipient by the subscriber 2, the server computer 8 will examine the databases to determine whether the intended recipient appears on those lists. If so, the server computer 8 will notify the subscriber 2 and refuse to allow communications to be created for the intended recipient.

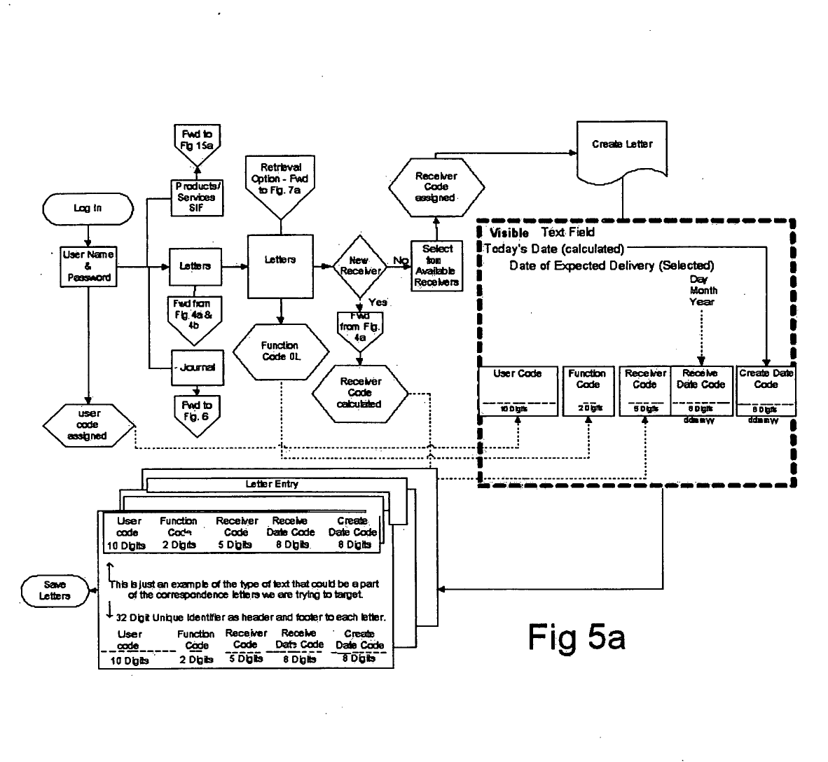

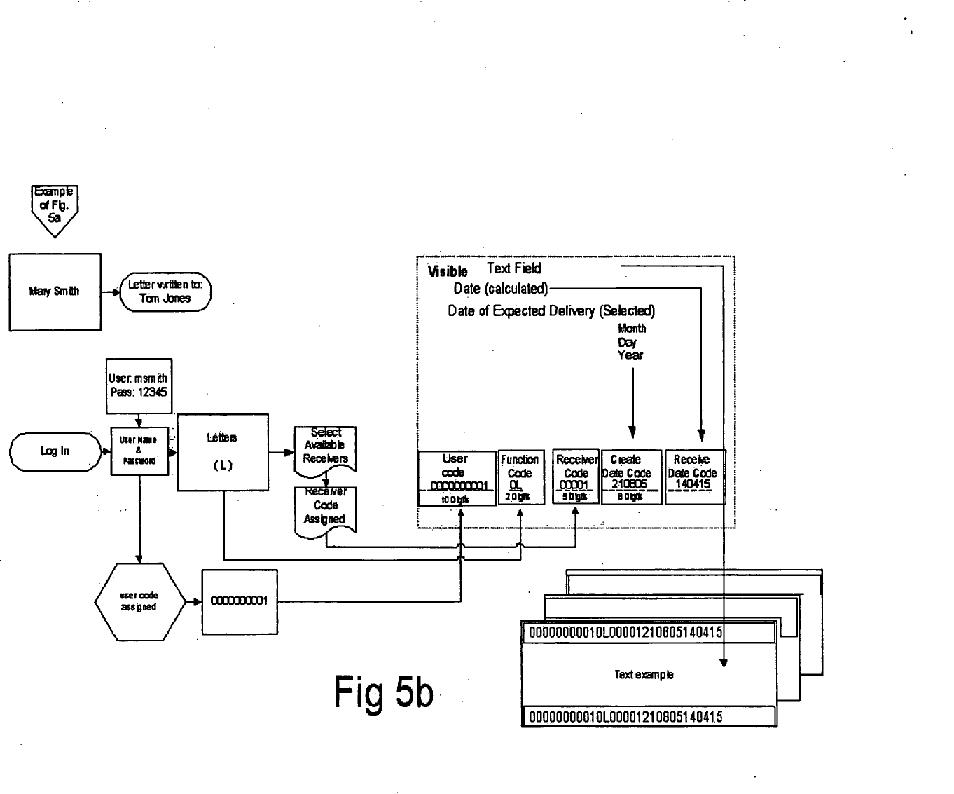

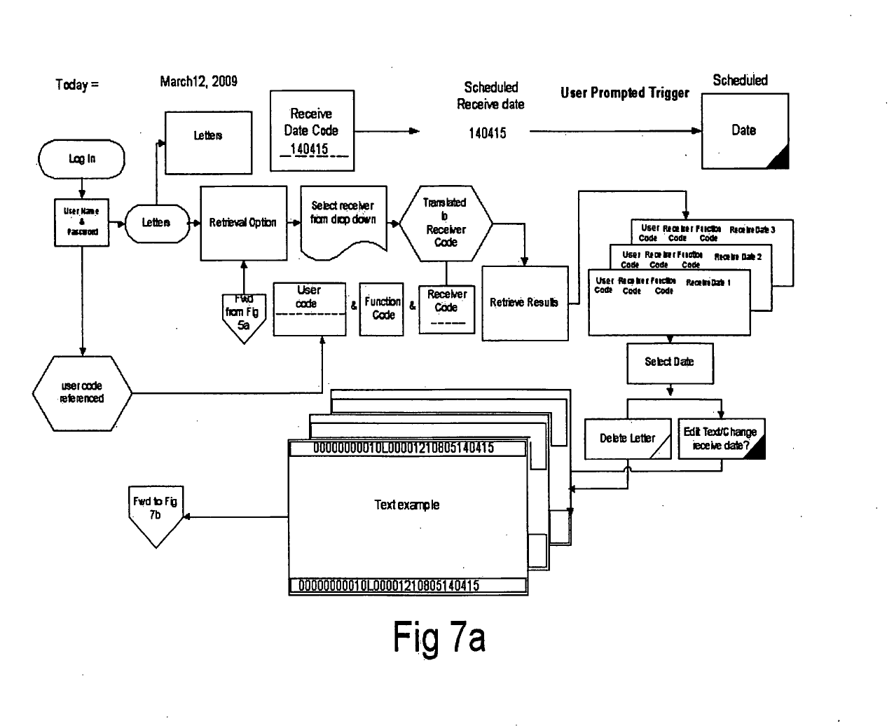

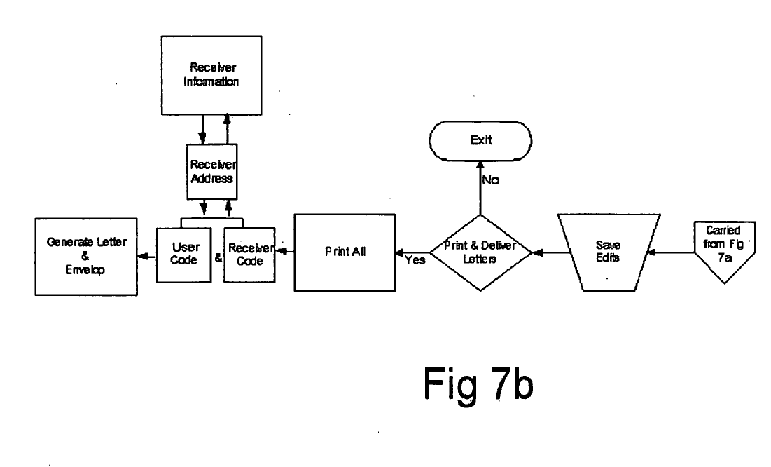

FIGS. 5a and 5b address the steps of creating a written communication in the form of a letter. The subscriber 2 will log onto the web site by providing his or her user name and password when prompted. The subscriber 2 will navigate to “letter write” screens and will prepare a letter or other written communication. The subscriber 2 will designate an intended recipient from the list of intended recipients associated with subscriber 2's account. The subscriber 2 will also designate a predetermined condition for delivery of the letter, which may be a future date certain. The date of letter creation and the predetermined condition for delivery are imbedded into the header or footer of the letter and the letter is saved to computer memory 10 by the server computer 8. The subscriber 2 may log onto the web site and reopen the letter at a later time to revise or otherwise edit the communication, as described below relating to FIGS. 7a and 7b.

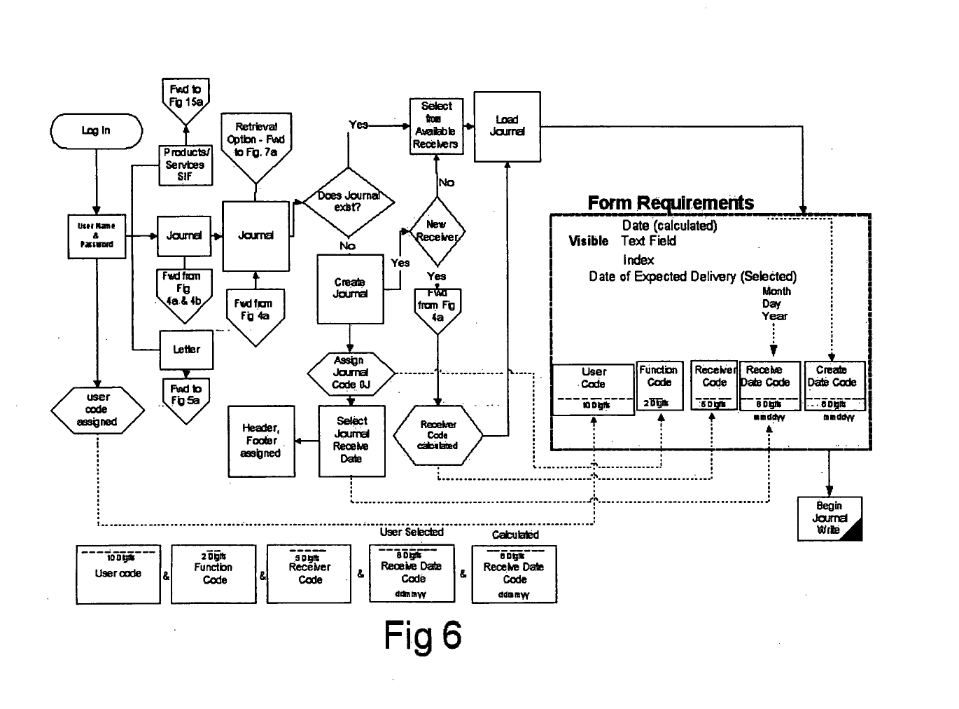

FIG. 6 describes the “journal create” function. The journal create function allows the subscriber 2 to make sequential or continuing entries into a single communication for future delivery to the designated recipient. For the journal create function, the subscriber 2 first logs onto the web site and selects the journal function. The subscriber 2 can open an existing journal or create a new journal. For a new journal the subscriber 2 will select a designated recipient from the list of designated recipients associated with the subscriber 2's account and will select a predetermined condition for delivery of the journal. If the journal already exists, the subscriber 2 can open the existing journal and make new entries. The journal can be configured to display in a header or footer the date, time and location of the subscriber 2 at the time of creation of the journal entry and a sentiment heading.

FIGS. 7a and 7b illustrate the “user prompted letter retrieval” function. Using this function, the subscriber 2 can retrieve a letter at any time prior to the occurrence of the predetermine condition. The subscriber 2 will log onto the web site, select ‘letters’ and select ‘letter retrieval.’ The subscriber 2 will then select the intended recipient and all communications to that intended recipient will be revealed. The subscriber 2 then can select the communication of interest, which is presented on the screen for review and editing. The subscriber 2 can change the predetermined condition for delivery or delete the letter entirely. The subscriber 2 has the option of directing that one or more letters be immediately printed and delivered to the intended recipient. If a letter or any of the specifications of the letter are amended, the subscriber 2 can save the letter to computer memory 10 associated with the server computer 8. The subscriber 2 can exit the letter retrieval screen and return to the letters screen.

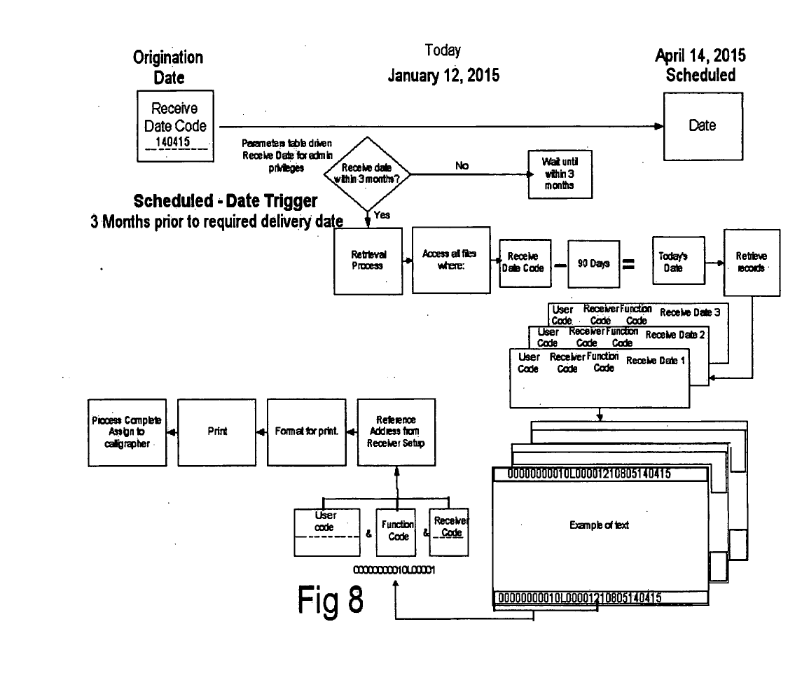

FIG. 8 shows the initiation of the process of delivery of the communication, particularly a written communication where the predetermined condition is a date certain. Each written communication will include a date code corresponding to the predetermined condition. At a time prior to the date certain, for example three months, the server computer 8 system will retrieve the written communication and format the written communication for printing in preparation for delivery. As indicated on FIG. 8, the printed communication may be assigned to a calligrapher if that service is ordered by subscriber 2.

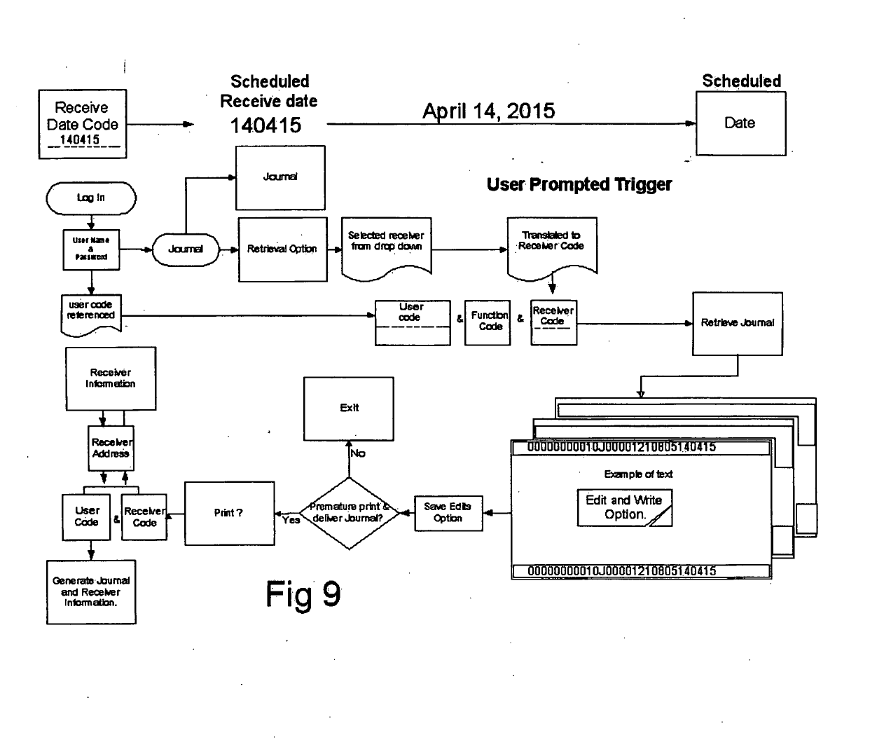

FIG. 9 illustrates the “user prompted journal retrieve” function. Similar to the user prompted letter retrieve function of FIGS. 7a and 7b, the journal retrieve function allows the subscriber 2 to access an existing journal. The subscriber 2 will log onto the web site and select to retrieve the journal. The journal is presented on the screen for review and editing. The subscriber 2 can change the predetermined condition for delivery or delete the journal entirely. The subscriber 2 has the option of directing that one or more journals be immediately printed and delivered to the intended recipient. If a journal or any of the specifications of the journal are amended, the subscriber 2 can save the journal to computer memory 10 associated with the server computer 8. The subscriber 2 can exit the journal retrieval screen and return to the journal screen.

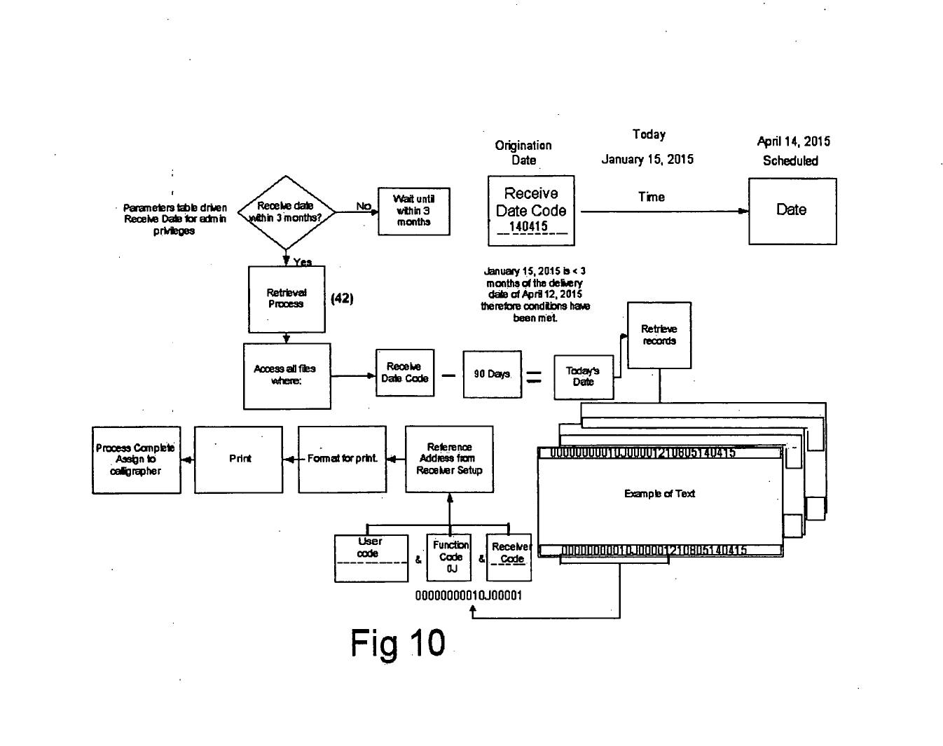

FIG. 10 is the “journal schedule retrieve” process, which is similar to the retrieval and printing process for a letter as described in FIG. 10 above. The server computer 8 automatically reviews the predetermined conditions for delivery of each journal. If the date of the review is within a specified date range of the date certain specified as the predetermined condition for delivery of the journal, the server computer 8 causes the journal to be printed in a specified format. If the subscriber 2 has ordered a calligraphy service, the printed journal is referred to a calligrapher for completion.

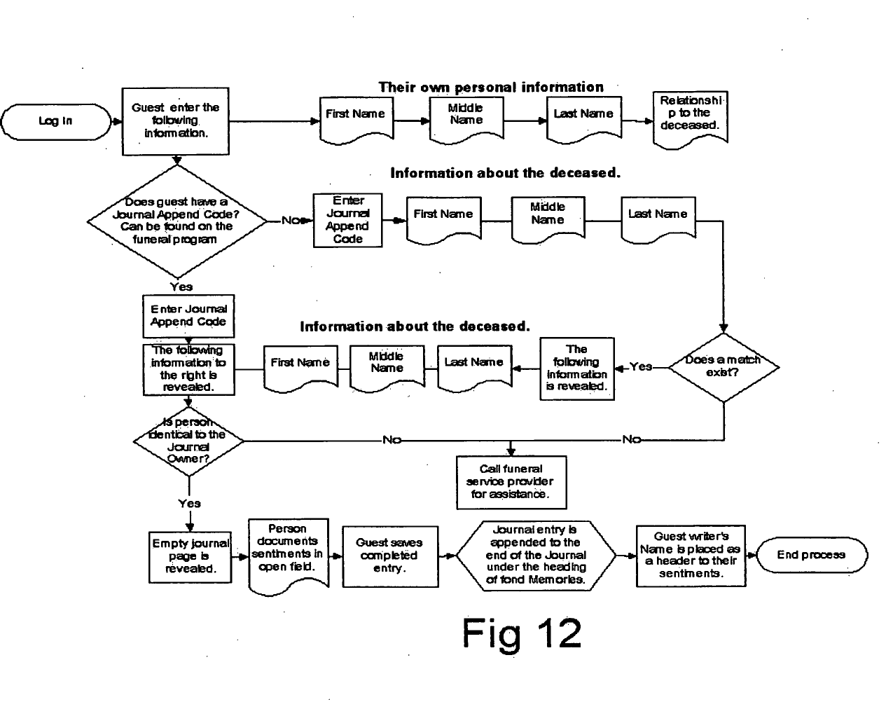

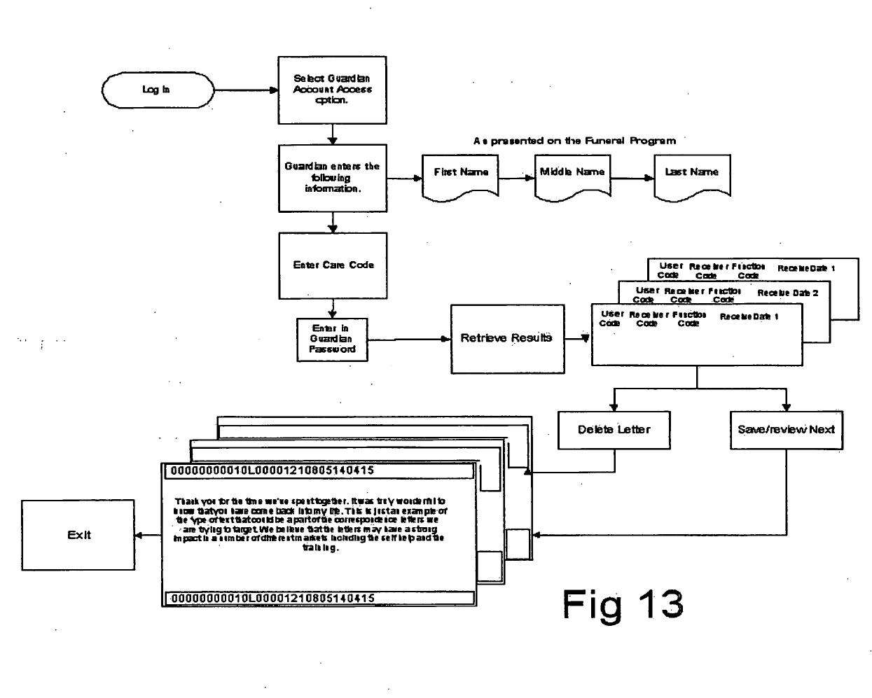

FIG. 11 addresses the access to the account of the subscriber 2 by a funeral services provider in the event of the death of the subscriber 2. A “family access code” optionally is created for the account at the time of creation of the account through the “guardian access” option, described below with respect to FIG. 13. The family of the deceased subscriber 2 provides the family access code to a funeral services provider. The funeral services provider acquires a “funeral services access code” by subscription from the delivery services provider 12. Possession of both the family access code and the funeral services access code provides the funeral services provider with access to the journals or memoirs created by the subscriber 2. The funeral services provider can allow third parties to append messages or eulogies of the deceased subscriber 2 to the subscriber 2's journal, as described in FIG. 12.

FIG. 12 includes the “append function” for use in the situation of a deceased subscriber 2. A “journal append” code is published in a funeral program or a published obituary, or otherwise is made available to interested persons. An interested person logs onto the web site maintained by the delivery services provider 12 and onto the journal of the deceased subscriber 2 using the “journal append” code. The interested person provides identifying information and is prompted to enter a remembrance or eulogy of the deceased subscriber 2, images relating to the deceased subscriber 2 or condolences to survivors. The journal append function is available for a predetermined period of time to allow interested persons to submit entries. The “journal append” function is particularly applicable to pre-need funeral services offered by a funeral services provider. The subscriber 2 may subscribe to the delivery service and to the journal append function as part of a package of services offered by the funeral services provider.

“Guardian access,” described by FIG. 13, allows a person designated by the subscriber 2 to gain access to the entries created by interested persons pursuant to the “journal append” feature discussed above relating to FIG. 12. The designated person may review, edit or delete appended entries made by interested persons where the designated person determines that such review, editing or deletion is appropriate. If the designated person approves an entry by an interested person, the entry will be included in the final journal for printing under a section entitled “loving sentiments.”

The “receiver opt-out” function is illustrated by FIG. 14. An intended recipient may not wish to receive communications from the subscriber 2. Each communication provided to an intended recipient from a subscriber 2 by a delivery services provider 12 will include identifying information and instructions on removing the person from the list of intended recipients to receive communications. Following the instructions provided, the person who does not wish to receive communications can log onto the web site maintained by the delivery services provider 12. The person will select the receiver opt-out function and enter the “receiver code” included in the communication. The person will be presented with two options—first, to receive no further communications from the subscriber 2 and second, to receive no further communications from anyone.

If the person selects the first option, the subscriber 2 will be blocked from sending communications to the person and any existing communications to the person from the subscriber 2 will be stopped. Communications that are composed by the subscriber 2 and waiting for the predetermined condition to occur prior to delivery to the person will be prevented from being delivered and will be stored by the delivery services provider 12 for a predetermined period of time. If the person selects the second option, the person will be removed from the list of intended recipients, will be placed on a ‘do not contact’ list and will receive no communications from any subscriber 2.

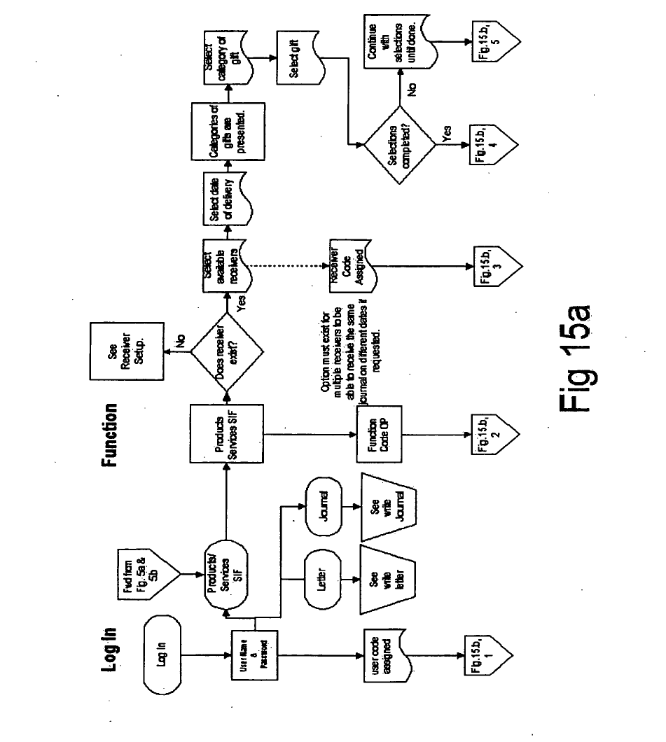

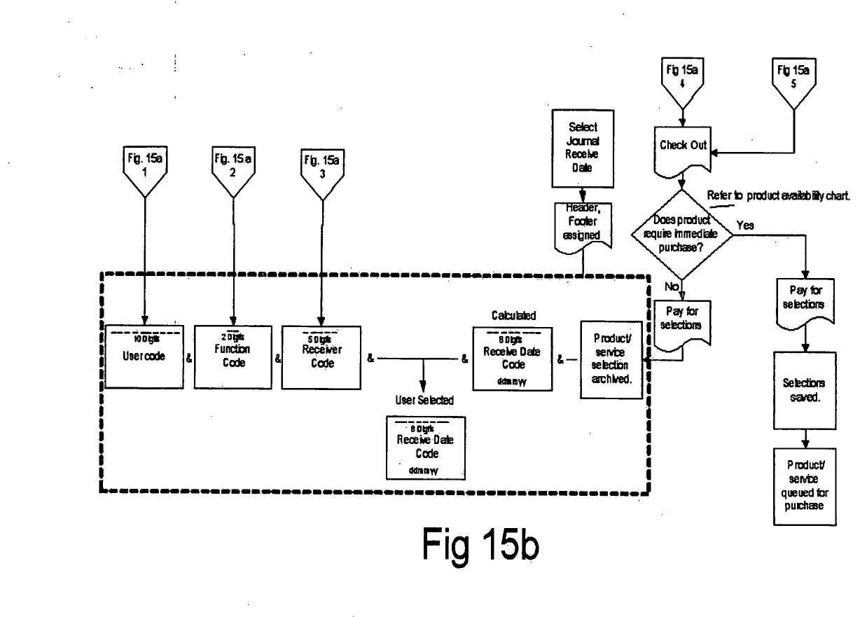

FIGS. 15a and 15b illustrate the ordering of a good or service as part of a communication for future delivery to an intended recipient. FIGS. 15a and 15b are similar in structure to the journal create function illustrated by FIG. 6. To order a good or service, the subscriber 2 first logs onto the web site and selects the order good or service function. The subscriber 2 can open an existing order for future delivery of a good or service or can create a new order. For a new order, the subscriber 2 will select a designated recipient from the list of designated recipients associated with the subscriber 2's account and will select a predetermined condition for delivery of the good or service. If the order already exists, the subscriber 2 can open the existing order and amend the order. Once the subscriber has completed his or her selections, the subscriber will proceed to check out. If the good or service is one that requires immediate payment, the subscriber will be prompted for payment information and the good or service delivered. If the good or service is scheduled for future delivery, the subscriber will be prompted to pay for the selections as specified by FIG. 2 above, through creation of a funded financial account with a financial institution or through the purchase of an insurance product.

In describing the above embodiments of the invention, specific terminology was selected for the sake of clarity. However, the invention is not intended to be limited to the specific terms so selected, and it is to be understood that each specific term includes all technical equivalents that operate in a similar manner to accomplish a similar purpose.

I claim:

1. A message delivery apparatus, the apparatus comprising:
a. a server computer, said server computer being adapted to communicate with a subscriber over a computer network;
b. said server computer being adapted to receive a request to create a subscription account from said subscriber and to create said subscription account for said subscriber based on said request;
c. said server computer being adapted to receive from said subscriber a communication, an identity of an intended recipient of said communication, a geographic location of said intended recipient, and an identification of a predetermined condition;
d. said server computer being adapted to associate with said subscriber account and to store in said computer memory said communication, said identity of said intended recipient of said communication, said geographic location of said intended recipient, and said identification of said predetermined condition;
e. means to deliver said communication to said intended recipient upon occurrence of said predetermined condition.

2. The apparatus of claim 1 wherein said communication is selected from a list consisting of a written communication, a good and a service, said means to deliver said communication to said intended recipient comprising:
a. said server computer being adapted to communicate with a delivery services provider;
b. said server computer being adapted to notify said delivery services provider of said predetermined condition;
c. means for said delivery services provider to cause said communication to be delivered to said intended recipient.

3. The apparatus of claim 2 wherein said communication is a written communication, said means to deliver said communication further comprising: a printer, said printer being adapted to print said written communication.

4. The apparatus of claim 2 wherein said predetermined condition is selected from a list consisting of: an occurrence of a calendar date, a passage of a specified period of time, and an occurrence of a life event.

5. The apparatus of claim 2, the apparatus further comprising:
a. said server computer being adapted to receive from said subscriber an authorization for said server computer to receive said communication from a person other than said subscriber;
b. said predetermined condition being defined by a death of said subscriber.

6. The apparatus of claim 2 wherein
a. said server computer being adapted to create a financial account with a financial institution upon direction by said subscriber;
b. said server computer being adapted to receive monies from said subscriber;
c. said server computer being adapted to deposit said monies to said financial account for a benefit of said subscriber;
d. said server computer being adapted to direct said financial institution to transfer all or a portion of said monies to said delivery services provider upon occurrence of said predetermined condition as a compensation for delivery of said communication to said intended recipient.

7. The apparatus of claim 2 wherein
a. said server computer being adapted to apply to an insurance provider for an insurance product upon an instruction by said subscriber, said insurance product being selected from a group consisting of a policy of whole life insurance, a policy of term life insurance and an annuity;
b. means for said delivery services provider to make a claim upon said insurance provider for a proceed of said insurance as compensation for delivery of said communication to said intended recipient.

8. The apparatus of claim 2, the apparatus further comprising:
a. said server computer being adapted to receive a financing instruction from said subscriber and to perform a financing action as instructed by said subscriber;
b. said financing action being selected from a list consisting of creating a financial account with a financial services provider on behalf of said subscriber and applying to an insurance provider for an insurance product on behalf of said subscriber, said insurance product being selected from a list consisting of a policy of whole life insurance, a policy of term life insurance and an annuity;
c. said server computer being adapted to receive a payment from said financial services provider or from said insurance provider upon said occurrence of said predetermined event as compensation to said delivery services provider for delivery of said communication to said intended recipient.

9. A communication delivery method, the method comprising:
a. accessing by a subscriber or a sales agent of a server computer over a computer network;
b. submitting by said subscriber or said sales agent to said server computer of a request to create a subscription account for said subscriber;
c. creating by said server computer of said subscription account in response to said request;
d. submitting by said subscriber or said sales agent to said server computer of a communication, an identity of an intended recipient of said communication, a geographic location of said intended recipient, and an identification of a predetermined condition;
e. associating by said server computer with said subscription account of said communication, said identity of said intended recipient, said geographic location of said intended recipient, and said identification of said predetermined condition;
f. storing by said server computer in a computer memory of said communication, said identity of said intended recipient, said geographic location of said intended recipient, and said identification of said predetermined condition;
g. delivering said communication to said intended recipient upon occurrence of said predetermined condition.

10. The method of claim 9 wherein said step of delivering said communication to said intended recipient comprises:
a. communicating by said server computer with a delivery services provider;
b. notifying of said delivery services provider by said server computer of said occurrence of said predetermined condition;
c. causing by said delivery services provider of said communication to be delivered to said intended recipient.

11. The method of claim 10 wherein said communication is selected from a list consisting of a written communication, a good and a service.

12. The method of claim 11 wherein said communication is a written communication, said step of causing said communication to be delivered further comprising:
a. printing said written communication;
b. delivering said printed written communication to said intended recipient.

13. The method of claim 11 wherein said predetermined condition is selected from a list consisting of passage of a term of years, occurrence of a calendar date and occurrence of a life event.

14. The method of claim 11, the method further comprising: said server computer being adapted to receive from said subscriber an authorization for said server computer to receive said communication from a person other than said subscriber.

15. The method of claim 14 wherein said predetermined condition is a death of said subscriber.

16. The method of claim 11, the method further comprising:
a. receiving by said server computer of a request by said subscriber to create a financial account with a financial institution;
b. creating by said server computer of said financial account with a financial institution for a benefit of said subscriber;
c. receiving by said server computer of monies from said subscriber;
d. depositing of said monies by said server computer in said financial account with said financial institution;
e. paying by said financial institution of all or a portion of said monies to said delivery services provider upon occurrence of said predetermined condition in compensation for said delivery of said communication to said intended recipient by said delivery services provider.

17. The method of claim 11, the method further comprising:
a. receiving by said server computer of a request to submit an application for an insurance product, said server computer receiving said request from said subscriber;
b. transmitting by said server computer of said application for said insurance product to an insurance provider;
c. receiving by said server computer of an insurance product premium from said subscriber, said server computer paying said premium to said insurance provider;
d. paying by said insurance provider of a proceed of said insurance product to said delivery services provider in compensation for said delivery by said delivery services provider of said communication to said intended recipient by said delivery services provider.

18. The method of claim 17 wherein said insurance product is selected from a list consisting of a policy of whole life insurance, a policy of term life insurance and an annuity.

19. The method of claim 13, the method further comprising:
a. receiving by said server computer of a request by said subscriber, said request being selected from a list consisting of a creation of a financial account with a financial institution, a purchase of a policy of whole life insurance from an insurance provider, a purchase of a policy of term life insurance from an insurance provider, and a purchase of an annuity from an insurance provider;
b. creating said financial account, purchasing said policy of whole life insurance, purchasing said policy of term life insurance or purchasing said annuity, consistent with said request from said subscriber.

20. The method of claim 19, the method further comprising:
a. paying by said financial institution of money deposited in said financial account to said delivery services provider upon occurrence of said predetermined condition where said subscriber requested creation of said financial account;
b. paying by said insurance provider of a proceed of said whole life insurance policy to said delivery services provider upon occurrence of said predetermined condition where said subscriber requested purchase of said whole life insurance policy;
c. paying by said insurance provider of a proceed of said term life insurance policy to said delivery services provider upon occurrence of said predetermined condition where said subscriber requested purchase of said term life insurance policy;
d. paying by said insurance provider of a proceed of said annuity to said delivery services provider upon occurrence of said predetermined condition where said subscriber requested purchase of said annuity, said paying by said financial institution or said insurance provider to said delivery services provider is compensation to said delivery services provider for said delivery of said communication to said intended recipient.
